(19) United States
(12) Patent Application Publication
(10) Pub. No.: US 2015/0164046 A1
(43) Pub. Date: Jun. 18, 2015

(54) RETRIEVABLE OBJECTS AND THROWING DEVICES FOR THROWING THE RETRIEVABLE OBJECTS

(71) Applicant: Elive LLC, New Berlin, WI (US)

(72) Inventors: Thomas Lutz, Cedar Rapids, IA (US); Ernie Katris, New Berlin, WI (US)

(21) Appl. No.: 14/567,586

(22) Filed: Dec. 11, 2014

Related U.S. Application Data
(60) Provisional application No. 61/915,804, filed on Dec. 13, 2013.

(51) Int. Cl. A01K 15/02; A01K 5/00; F41B 3/00; A01K 29/00

(52) U.S. Cl. CPC A01K 15/025; A01K 15/027; A01K 29/00; A01K 5/00; F41B 3/00

(57) ABSTRACT

A pet device includes a handle and a body coupled to the handle. The pet device also includes a food dispenser coupled to the handle or the body. The food dispenser includes a housing to receive a plurality of pet food items. Either the handle or the body includes an opening to dispense the pet food items from the food dispenser.

### CROSS-REFERENCE TO RELATED APPLICATIONS

This application claims priority to U.S. Provisional Application No. 61/915,804, filed Dec. 13, 2013, the entire contents of which are incorporated herein by reference.

### FIELD OF THE INVENTION

The present invention relates to retrievable objects, particular retrievable pet objects, and to throwing devices for throwing the retrievable objects.

### BACKGROUND

A yellow tennis ball is commonly used as a retrievable object, especially for dogs. Current throwing devices are used to throw yellow tennis balls to a dog or other pet.

A flying disc is also commonly used as retrievable pet object, especially for dogs. The flying disc is thrown by hand to a dog, who retrieves the flying disc and returns it to the owner.

### SUMMARY

In accordance with one construction, a pet device includes a handle and a body coupled to the handle. The pet device also includes a food dispenser coupled to the handle or the body. The food dispenser includes a housing to receive a plurality of pet food items. Either the handle or the body includes an opening to dispense the pet food items from the food dispenser.

In accordance with another construction, a pet toy throwing device includes a handle and a body coupled to a first end of the handle. The body is selected from a group consisting of a scoop, a U-shaped pouch, and a U-shaped sling-shot. The pet toy throwing device also includes a food dispenser coupled to a second, opposite end of the handle. The food dispenser includes a housing to receive a plurality of pet food items, and a biasing member disposed within the housing to bias the food items toward the second end of the handle. The second end of the handle includes an opening to dispense the pet food items from the food dispenser. The opening includes a first portion along a bottom of the handle and a second portion along a side of the handle.

Other aspects of the invention will become apparent by consideration of the detailed description and accompanying drawings.

### BRIEF DESCRIPTION OF THE DRAWINGS

FIG. 1 is a perspective view of a throwing device and a flying disc according to one construction.

FIG. 2 is a perspective view of the throwing device of FIG. 1, with the flying disc coupled to the throwing device.

FIG. 3 is a perspective view of the flying disc, illustrating a set of teeth on the flying disc.

FIG. 4 is a perspective view of a portion of the throwing device and the flying disc, illustrating a set of ribs on the flying disc throwing device.

FIG. 5 is a perspective view of a throwing device according to another construction.

FIG. 6 is a perspective view of the throwing device of FIG. 5, along with two differently-sized balls resting within the throwing device.

FIG. 7 is a partial perspective view of a handle and food dispenser of the throwing device of FIG. 5.

FIG. 8 is a perspective view of the food dispenser, with the handle removed.

FIG. 9 is a perspective view of a biasing member inside of the food dispenser.

FIG. 10 is a front perspective view of a throwing device according to another construction.

FIG. 11 is a back perspective view of the throwing device of FIG. 10.

FIG. 12 is a schematic view of a dog leash with a handle incorporating a food dispenser.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

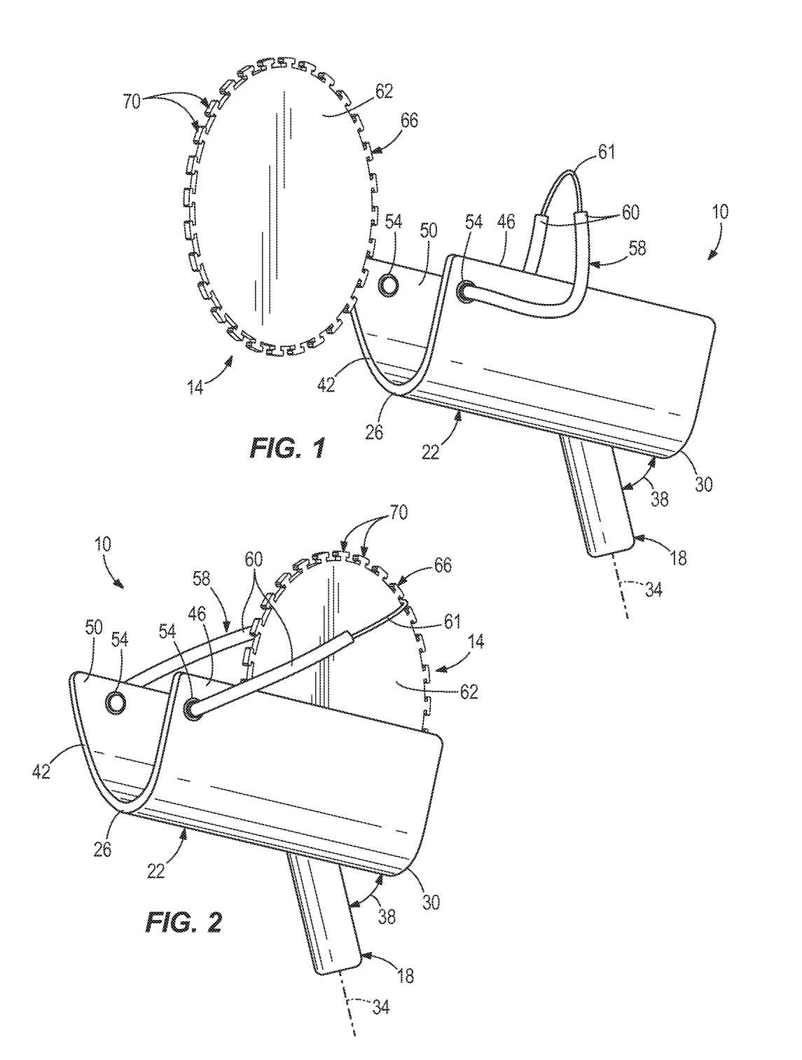

FIGS. 1-4 illustrate a throwing device 10 for throwing one or more flying discs 14. While the illustrated throwing device 10 is described and illustrated in the context of a device for throwing flying discs 14 to a pet, the throwing device 10 may be used to throw various other objects as well, including but not limited to other types of disks or retrievable pet objects. In some constructions the throwing device 10 may be used to throw objects to another person or to a target, as opposed to a pet.

With reference to FIGS. 1 and 2, the throwing device 10 includes a handle 18 and an elongate body 22 coupled to the handle 18. The illustrated body 22 includes a front portion 26 and a rear portion 30, with the handle 18 coupled closer to the rear portion 30 than to the front portion 26. As illustrated in FIGS. 1 and 2, the handle 18 extends along an elongate axis 34 that is angled relative to the body 22 by an angle 38. The angle 38 is between approximately 75-80 degrees, although other constructions include different values and ranges. For example, in some constructions the angle 38 is between 60 and 85 degrees.

With reference to FIGS. 1, 2, and 4, the body 22 has a generally U-shaped configuration, forming a pouch with a first side 42, a second side 46, and an inner surface 50 (e.g., a track) for receiving and guiding one or more of the flying discs 14 within the body 22. The illustrated body 22 is rigid, although in some constructions the body 22, or portions of the body 22, are flexible.

With reference to FIGS. 1 and 2, the body 22 includes two apertures 54 for receiving and coupling a biasing member 58 to the body 22. One of the apertures 54 is disposed on the first side 42, and the other aperture 54 is disposed on the second side 46. Both apertures 50 are disposed on the front portion 26 of the body 22. The illustrated biasing member 58 includes two elastic bands 60 and a cable 61 disposed between the elastic bands 60, although other constructions include different structures for the biasing member 58. In some constructions more than one biasing member 58 is used. The biasing member 58 extends between the two apertures 54, and as illustrated in FIG. 2, is stretched generally in a direction toward the rear portion 30 when the flying disc 14 is pulled into and disposed within the body 22.

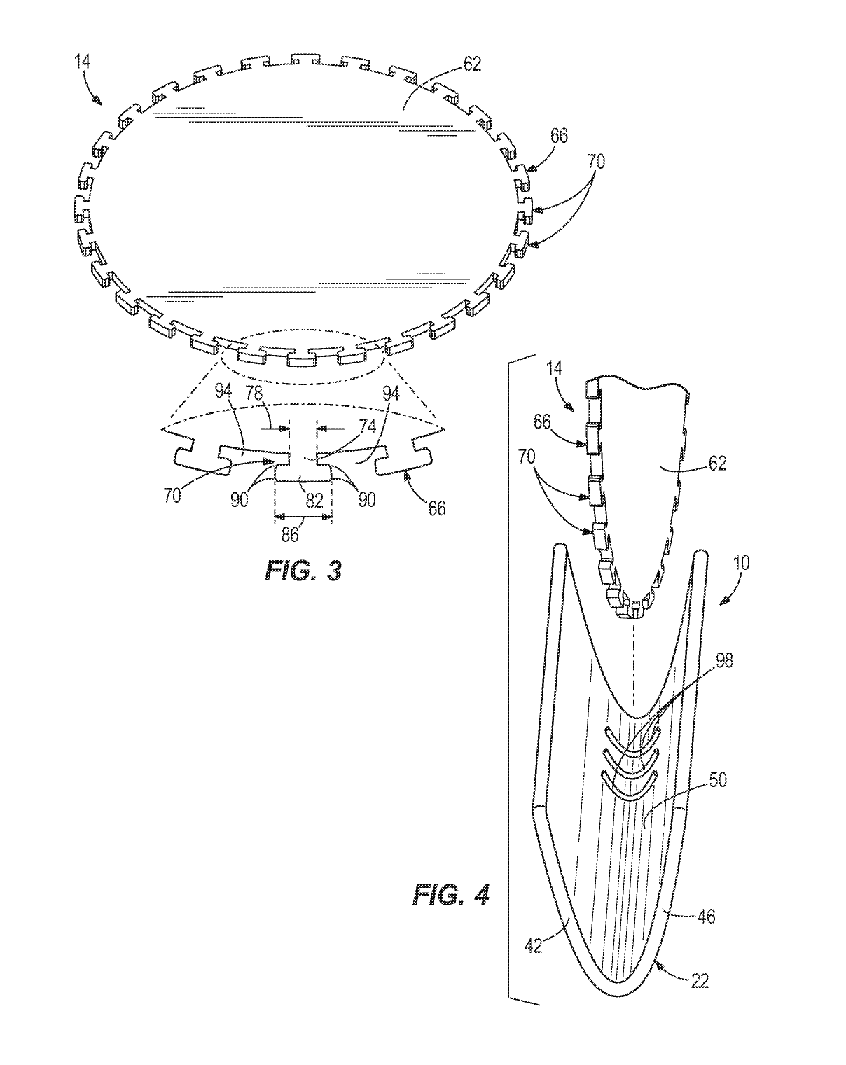

With reference to FIGS. 1-4, the flying disc 14 includes a top surface 62 (e.g., generally planar, frustoconical, or other shape) and an outer periphery 66. A set of teeth 70 are disposed along at least a portion of the outer periphery 66. As illustrated in FIG. 3, each of the teeth 70 includes a first portion 74 having a first width 78 and a second portion 82 having a second, larger width 86 such that the teeth are generally T-shaped in cross section. The second portion 82 is disposed radially outwardly of the first portion 74. The second portion has rounded corners 90 so as to prevent sharp edges along the periphery 66. As illustrated in FIGS. 2 and 3, the cable 61 of the biasing member 54 is sized and configured to fit in a channel 94 between two of the teeth 70 and to engage one or more of the first portion 74 and the second portion 82 to grasp and hold the flying disc 14 when the flying disc 14 is disposed within the body 22.

With reference to FIG. 4, the illustrated body 22 also includes a set of ribs 98 along the inner surface 50. The ribs 98 engage one or more of the teeth 70, and act as a catch to inhibit the flying disc 14 from prematurely leaving the body 22 after the flying disc 14 has been pulled into the body 22. In some constructions the flying disc 14 is rolled back into the body 22 against a force of the biasing member 58, and the teeth 70 catch on the ribs 98 like a ratcheting mechanism, such that the ribs 98 impart increasing rotational potential energy to the flying disc 14 as the flying disc 14 is rolled back farther into the body 22. The illustrated construction includes three ribs 98, although other constructions include different numbers of ribs 98. In some constructions a structure other than a rib is used to impart rotational potential energy to the flying disc 14. Some constructions may include no ribs 98 and may rely on friction between the flying disc 14 and the body 22.

To throw the flying disc 14, the handle 18 is gripped by a user such that the device 10 is held and aimed sideways (e.g., with the axis 34 of the handle 18 extending substantially parallel to a surface upon which a user is standing). The biasing member 58 is placed into engagement with one or more of the teeth 70. The flying disc 14 is then pulled (e.g., rolled and/or slid) back into body 22 toward the rear portion 30. As the flying disc 14 is pulled back, the biasing member 58 stretches, generating potential energy in the biasing member 58, and the flying disc 14 engages one or more of the ribs 98.

With the handle 18 still held, the user then releases the flying disc 14 and the biasing member 58. The potential energy built up in the biasing member 58 converts into kinetic energy, pushing the flying disc 14 toward the front portion 26. The biasing member 58 imparts a rotational spin to the flying disc 14 by pulling forward on one or more of the teeth 70 and rotating the flying disc 14 as the flying disc 14 is thrown out of the device 14. After the flying disc 14 is thrown out of the device 14, the user's pet (e.g., a dog) then retrieves the flying disc 14 and returns it to the user, wherein the process may be repeated.

In some constructions, a more standard flying disc is employed with minor modifications to make the flying disc suitable for use with the device 10. For example, a stiffening bar may be positioned across the diameter of the flying disc to stiffen the flying disc in that diametrical direction to inhibit the tendency of the flying disc to deform or “taco” during the launching process. In addition, rather than including teeth as illustrated in FIGS. 1-4, the flying disc may include a single protrusion, hook, or slot that can be engaged by the biasing member for launching the flying disc.

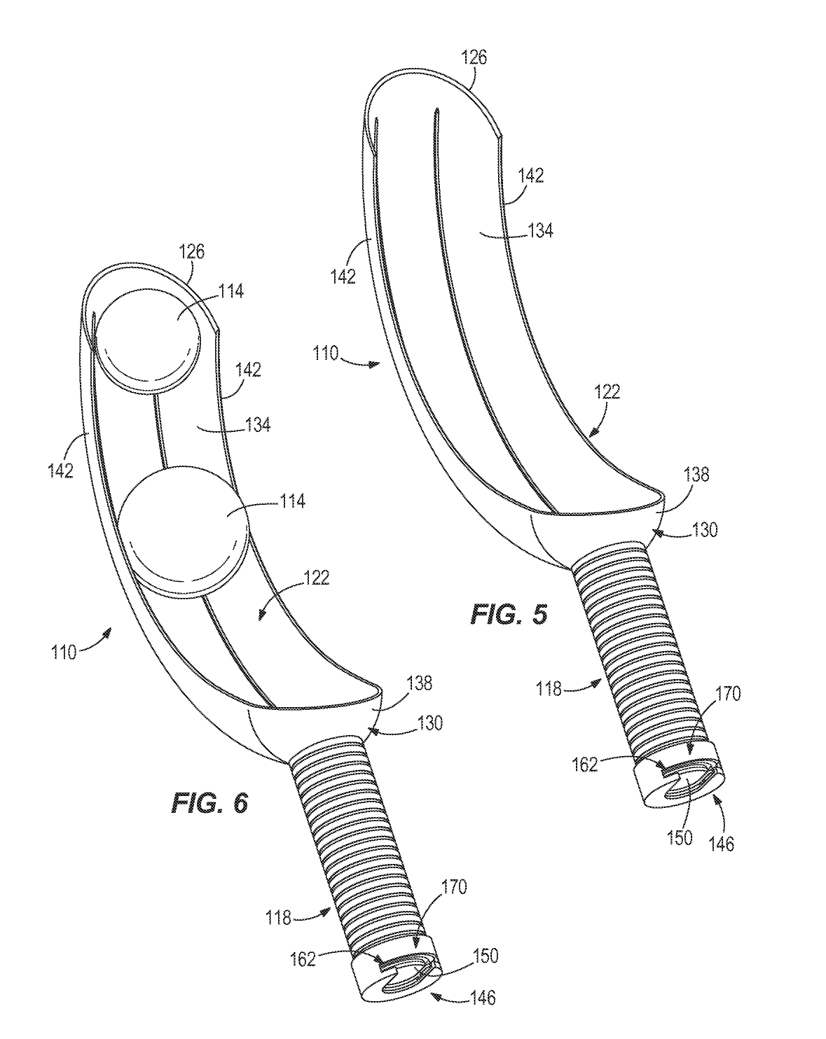

FIGS. 5-9 illustrate a throwing device 110 for throwing one or more balls 114. While the illustrated throwing device 110 is described and illustrated in the context of a device for throwing balls 114, the throwing device 110 may be used to throw various other objects as well, including but not limited to other types of retrievable pet objects. In some constructions the throwing device 110 may be used to throw objects to another person or to a target, as opposed to a pet.

With reference to FIG. 5, the throwing device 110 includes a handle 118 and an elongate body 122 coupled to the handle 118. The body 122 includes a top portion 126 and a bottom portion 130, the handle 118 being coupled to the bottom portion 130. The body 122 has a scoop-like configuration, with a curved inner surface 134 for receiving one or more balls 114 (FIG. 6). The top portion 126 is open-ended for receiving and throwing the balls 114 out of the body 122, and the bottom portion 130 includes a ledge 138 for at least partially retaining the balls 114. The body 122 also includes sidewalls 142 for partially retaining the balls 114.

To throw one of the balls 114, the ball 114 is placed within the body 122 (e.g., scooped up using the body 122 itself or placed inside the body 122 with a user's hand). Grasping the handle 118, the user swings the throwing device 110 forward (e.g., overhand), causing the ball 114 to slide and/or roll along the surface 134 and then exit out of the open top portion 126. The user's pet (e.g., a dog) then retrieves the ball 114 and returns it to the user.

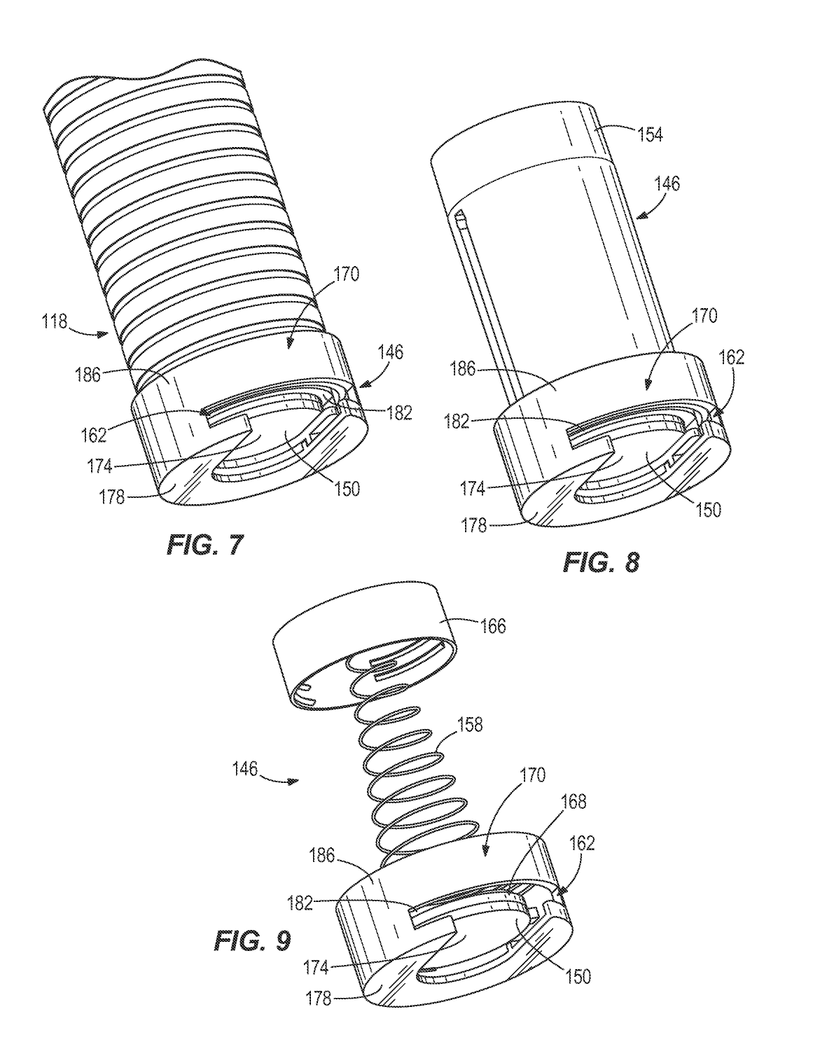

With continued reference to FIGS. 7-9, the throwing device 110 also includes a food dispenser 146 built into the handle 118 for dispensing food items 150 (e.g., pet treats including disc-shaped pet treats such as those illustrated in FIGS. 7-9). The food dispenser 146 includes a housing 154 (FIG. 8) that houses a biasing member 158 (FIG. 9). In some constructions the housing 154 is integrally formed as a single piece with the handle 118. In some constructions the housing 154 is removable from the handle 118. In some constructions the food dispenser 146 is coupled to the body 122 instead of the handle 118 (e.g., integrally formed as a single piece within the body 122 or removably coupled to the body 122).

The biasing member 158 biases the food items 150 toward an opening 162 (e.g., a slit) in the handle 118. The illustrated biasing member 158 is a compression spring, although other constructions include different types of biasing members. In the illustrated construction the biasing member 158 is coupled to an internal cap 166 at one end of the biasing member 158. The internal cap 166 fits within the housing 154. The biasing member 158 is coupled to a pressing member 168 (FIG. 9) at an opposite end of the biasing member 158. The pressing member 166 presses down on one or more of the food items 150 to bias the items 150 toward the opening 162. In some constructions, such as that illustrated in FIG. 7, only a single food item 150 is exposed through the opening 162.

The food dispenser 146 may be loaded by with food items 150 by removing an end cap 170 on the handle 118. With the end cap 170 removed, a stack of food items 150 may be pressed up into the housing 154, compressing the biasing member 158. The opening 162 for removal of each food item 150 is disposed in the end cap 170, although in other constructions the opening 162 is disposed elsewhere. As illustrated in FIGS. 7-9, the opening 162 includes a first portion 174 disposed on a bottom 178 of the end cap 170 to grip one of the food items 150 (e.g., with a finger) and a second portion 182 disposed on a side 186 of the end cap 170 through which the food item 150 is slid out of the handle 118 (e.g., with the same finger). The food dispenser 146 may be used to reward a pet, for example, once the pet has returned the ball 114.

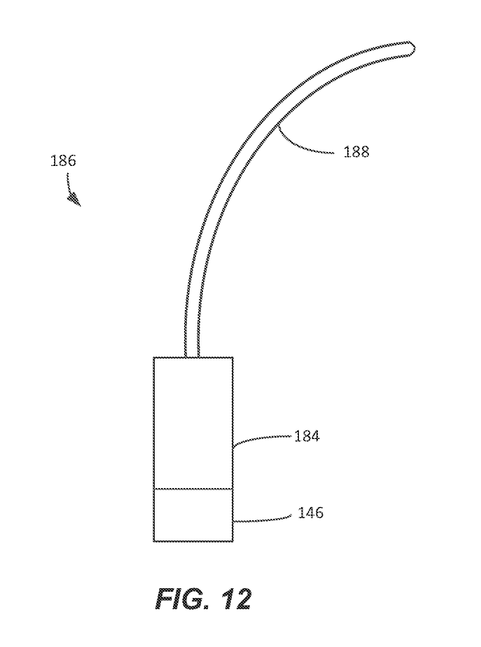

With reference to FIG. 12, in some constructions a food dispenser (e.g., food dispenser 146) is coupled to the handle 184 of a dog leash 186, the leash having a body 188 in the form of a flexible leash element (e.g., standard or retractable). In some constructions the food dispenser is coupled to other pet throwing devices or pet devices.

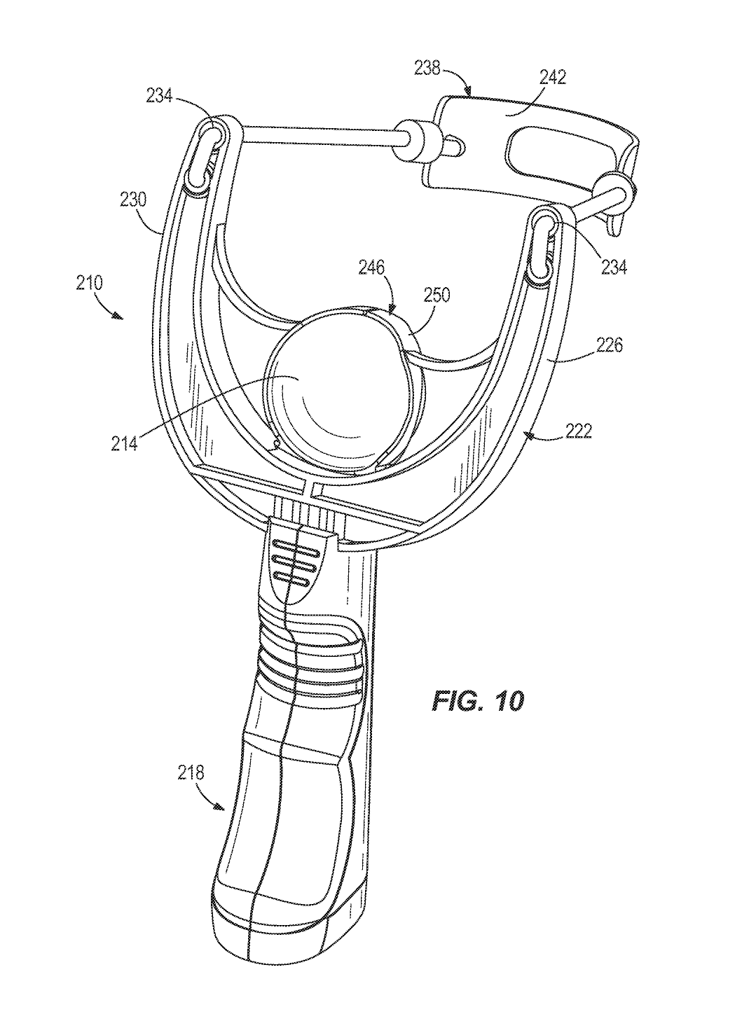

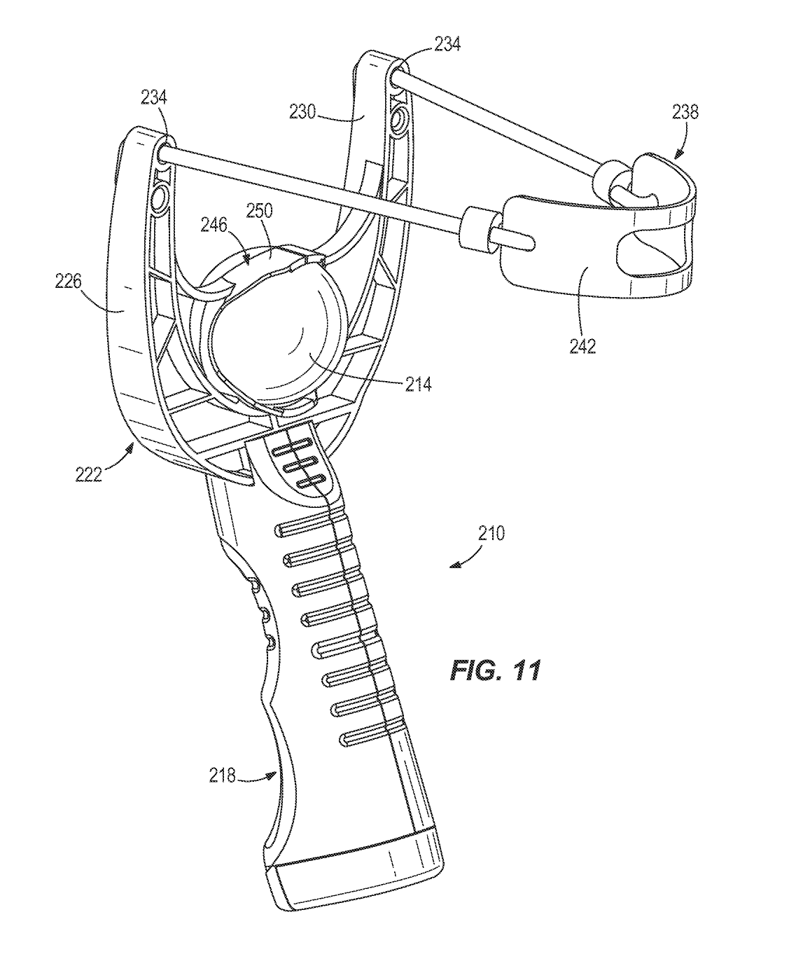

FIGS. 10 and 11 illustrate a throwing device 210 for throwing one or more balls 214. While the illustrated throwing device 210 is described and illustrated in the context of a device for throwing balls 214, the throwing device 210 may be used to throw various other objects as well, including but not limited to other types of retrievable pet objects. In some constructions the throwing device 210 may be used to throw objects to another person or to a target, as opposed to a pet.

The throwing device 210 includes a handle 218 and a body 222 coupled to the handle 218. The body 222 includes a first arm portion 226 and a second arm portion 230 that form a generally U-shaped body 222 (e.g., in the form of a slingshot), the handle 218 being coupled to a bottom of the U-shaped body 222. Each of the arm portions 226, 230 includes an aperture 234 for receiving and coupling a biasing member 238 to the body 222. The illustrated biasing member 238 is an elastic band, although other constructions include different structures for the biasing member 238. In some constructions, more than one biasing member 238 is used. The biasing member 238 extends between the two apertures 234, and includes a widened strap portion 242 for receiving and holding the ball 214.

To throw the ball 214, the ball 214 is placed in the strap portion 242. As the user holds the handle 218, the ball 214 and the strap portion 242 are pulled back, stretching the biasing member 238. The ball 214 and the strap 242 are then released, causing the ball 214 to fly forward out of the throwing device 210. The user's pet (e.g., a dog) then retrieves the ball 214 and returns it to the user.

With continued reference to FIGS. 10 and 11, the throwing device 210 also includes a storage member 246 coupled to the body 222. In the illustrated construction the storage member 246 is integrally formed as part of the body 222, and includes a rounded portion 250 disposed below the biasing member 238 that receives and holds the ball 214. The storage member 246 may be used to hold the ball 214 while the device 10 is not in use, or when another ball 214 is being thrown. In addition, the storage member 246 can be used to pick up a ball without having to touch the ball. The user simply positions the storage member 246 over the ball when the ball is resting on the ground. The user than pushes the throwing device 210 downward to engage the ball in the storage member 246.

While not illustrated, in some constructions the throwing device 210 and/or the throwing device 10 also each include a food dispenser, such as the food dispenser 146 described above, disposed within the handle 218, 18 or body 222, 22. The food dispenser is used to reward a pet, for example, once the pet has returned the ball 218 or the flying disc 14, respectively.

The flying discs 14 and balls 114, 214 described above may be any color or have any shape or pattern. However, unlike humans, who have three types of color receptors in their eyes (i.e., trichromatic), dogs only have two types of color receptors in their eyes (i.e., dichromatic). Dogs are not color blind, but because they have only two types of color receptors, it is difficult for a dog to differentiate between certain colors. The two color receptors create peak sensitivities at wavelengths around 429 nm and 555 nm of light, but also create a “dead spot” in a dog's vision at wavelengths between approximately 475 nm and 485 nm, making it difficult for dogs to differentiate between certain yellow and green objects. For example, it is difficult for a dog to identify a yellow ball (e.g., a tennis ball) resting in a field of green grass, as the ball and the grass look nearly the same. In contrast, dogs are much better at identifying objects with a blue or violet tint or coloring (e.g. having wavelengths of around 429 nm). With a blue or violet flying disc or ball, the dog may more easily differentiate between the flying disc or ball and the green grass, thus making it easier to find the flying disc or ball and retrieve it. In preferred constructions, the object being retrieved produces reflected light that is either high in the 429 nm plus or minus 20 nm range or 555 nm plus or minus 20 nm range. Most outdoor environments are dominated by yellow, green, or brown colors and are thus typically flooded with light in the 555 nm range. This fact makes objects that reflect light in the 429 nm range ideal for this application. Furthermore, in more preferred constructions, objects are made with at least two different colors (typically one in the 429 nm plus or minus 20 nm range and one in the 555 nm plus or minus 20 nm range) to help differentiate the object in multiple environments and also allow humans to see the object clearly.

Although the invention has been described in detail with reference to certain preferred embodiments, variations and modifications exist within the scope and spirit of one or more independent aspects of the invention as described.

1. A pet device comprising:
a handle;
a body coupled to the handle;
a food dispenser coupled to at least one of a group consisting of the body and the handle, the food dispenser including a housing to receive a plurality of pet food items;
wherein at least one of a group consisting of the body and the handle includes an opening to dispense the pet food items from the food dispenser.

2. The pet device of claim 1, wherein the pet device is a pet toy throwing device, and wherein the body is sized and shaped to receive a pet toy to be thrown from the body.

3. The pet device of claim 1, wherein the housing is disposed within the handle.

4. The pet device of claim 1, wherein the food dispenser includes a biasing member disposed within the housing, and a pressing member coupled to the biasing member.

5. The pet device of claim 4, wherein the biasing member is a compression spring coupled to the housing at a first end of the compression spring and coupled to the pressing member at an opposite end of the compression spring.

6. The pet device of claim 1, wherein the handle includes a removable end cap, and wherein the opening is disposed in the end cap.

7. The pet device of claim 6, wherein when the end cap is removed, room is provided for the plurality of pet food items to be pressed into the housing of the food dispenser.

8. The pet device of claim 6, wherein the opening includes a first portion disposed on a bottom of the end cap, and a second portion disposed on a side of the end cap.

9. The pet device of claim 1, wherein the housing is integrally formed as a single piece with the handle.

10. The pet device of claim 1, wherein the body is an elongate body that forms a generally U-shaped pouch and includes set of ribs disposed on an inner surface of the body.

11. The pet device of claim 10, further comprising a disc, the disc including at least one radially extending tooth that engages the set of ribs.

12. The pet device of claim 1, wherein the body has a scoop-like configuration with a curved inner surface to receive a pet toy.

13. The pet device of claim 12, further comprising a ball to be received in the body, the ball comprised of two colors, one color having a wavelength between 409 nm and 449 nm and the other color having a wavelength between 535 nm and 575 nm.

14. The pet device of claim 1, wherein the body has a generally U-shaped configuration and includes a storage member to store a first pet toy, and wherein the pet toy throwing device further comprises a strap portion coupled to the body that receives a second pet toy.

15. A pet toy throwing device comprising:
a handle;
a body coupled to a first end of the handle, the body selected from a group consisting of a scoop, a U-shaped pouch, and a U-shaped sling-shot; and
a food dispenser coupled to a second, opposite end of the handle, the food dispenser including a housing to receive a plurality of pet food items and a biasing member disposed within the housing to bias the food items toward the second end of the handle,
wherein the second end of the handle includes an opening to dispense the pet food items from the food dispenser, the opening including a first portion along a bottom of the handle and a second portion along a side of the handle.

16. The pet toy throwing device of claim 15, wherein the housing is integrally formed as a single piece with the handle.

17. The pet toy throwing device of claim 15, wherein the body is an elongate body that forms a generally U-shaped pouch and includes set of ribs disposed on an inner surface of the body.

18. The pet toy throwing device of claim 15, wherein the body has a scoop-like configuration with a curved inner surface to receive a pet toy.

19. The pet toy throwing device of claim 15, wherein the body has a generally U-shaped configuration and includes a storage member to store a first pet toy, and wherein the pet toy throwing device further comprises a strap portion coupled to the body that receives a second pet toy.

20. The pet toy throwing device of claim 15, further comprising a ball to be received in the body, the ball comprised of two colors, one color having a wavelength between 409 nm and 449 nm and the other color having a wavelength between 535 nm and 575 nm.
